(19) United States
(12) Patent Application Publication
(10) Pub. No.: US 2005/0014061 A1
(43) Pub. Date: Jan. 20, 2005

(54) Vehicle battery cover

(76) Inventor: Kil Jae Ahn, Hwaseong-si (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/763,919

(22) Filed: Jan. 22, 2004

(30) Foreign Application Priority Data
Jul. 16, 2003 (KR) 2003-48630

(51) Int. Cl. H01M 10/50; H01M 2/04

(52) U.S. Cl. 429/120; 429/176

(57) ABSTRACT

A vehicle battery cover for enhancing heat isolation includes a three-layer structure of a convection heat isolation member, a conduction heat isolation member and a radiant heat isolation member. With the present invention, it is possible to prevent the temperature of a battery from being increased excessively. In addition, the corners of a battery cover are foldable. When storing or transferring a large amount of battery covers, they are preferably folded, stored and transferred. When using the battery cover, the folded portions are unfolded, large space is not needed, and convenience in its use is enhanced.

### CROSS-REFERENCE TO RELATED APPLICATIONS

This application claims priority of Korean Application No. 10-2003-0048630, filed on Jul. 16, 2003, the disclosure of which is incorporated fully herein by reference.

### FIELD OF THE INVENTION

The present invention relates to a vehicle battery cover, and in particular to a vehicle battery cover for enhancing heat isolation using a multi-layer structure.

### BACKGROUND OF THE INVENTION

Generally, a vehicle battery comprises an anode plate, a cathode plate and an isolation plate in the interior of a cell casing. A plumbic acid battery filled with an electrolyte has been widely used. The battery is charged to a rated capacity by a generator and is discharged based on an increase of power consumption. This electric chemical operation is repeatedly performed. In a battery, when a temperature of the electrolyte is above 27° C., discharging capacity is increased as compared to a rated capacity for achieving a desired performance. However, when a temperature is decreased to less than 27° C., electric chemical operation of the battery becomes slow. In addition, since any adiabatic member is not adapted to a battery, an engine may be overheated. An engine is exposed to rather harsh heat condition in the summer.

In the case that a battery is left alone for a long time at a temperature of above 60° C., the temperature of an electrolyte is increased, and the operation material is separated. The polar plate can be damaged due to a corrosion of a polar plate lattice, so that a self-discharging operation is significantly increased. FIG. 1 is a graph showing a life of a battery under different temperature conditions. A battery of 80AH is left alone under three different temperature conditions of 40° C., 60° C. and 80° C. and their respective life was measured. As shown in FIG. 1, under a condition of 40° C., the life of the battery was 7000 hours, and under the conditions of 60° C. and 80° C., the life of the batteries are significantly decreased to 3700 hours and 2400 hours, respectively. The rate of decrease in life was 47% when the temperature was 60° C. as compared to 40° C. In addition, when the temperature was 80° C., the decrease of the life was 66%. In particular, at a relatively high temperature like 80° C., the life of the battery was significantly decreased. Therefore, it was shown that heat is very critical to the life of the battery.

As an example of a conventional battery, according to the Japanese patent laid-open No. 2001-185104, in a cheap battery cover, there are provided a box, a thin pad on an upper surface of the box, and a flap on an upper side of the box forming a handle/battery cover. According to the Japanese patent laid-open No. 2003-72387, there is provided a battery isolation structure consisting of four lateral walls for preventing a deformation of the battery container due to a temperature increase of the battery. According to the Japanese patent laid-open No. 2002-289171, a battery cover provides for water-resistance and vibration-resistance for a battery electrode. In addition, according to the Japanese patent laid-open No. Hei 8-2349, battery cover formed with a duel wall structure is provided for preventing a heat damage of a battery.

However, in the entire construction of the above-disclosed covers, the battery cover is simply designed to cover the outer appearance of a battery to prevent heat from being directly transferred to the battery. In addition, a sponge pad is provided in the interior of a battery cover. However, the sponge pad is simply directed to achieving an isolation effect with respect to convection heat transferred to a battery. However, as time goes by, surrounding heat is absorbed, and the absorbed heat is radiated to the battery, so that the temperature of the liquid of the battery is increased.

### SUMMARY OF THE INVENTION

An embodiment of the present invention provides a battery cover with a three-layer structure consisting of a convection heat isolation member, a conduction heat isolation member, and a radiant heat isolation member for thereby achieving an optimum performance of a battery by isolating all kinds of heats being transferred to battery from circumstances.

In a preferred embodiment, a battery cover comprises an outermost layer made of a convection heat isolation member, a middle layer made of a conduction heat isolation member, and an innermost layer made of a radiant heat isolation member. In a further preferred embodiment, a corner portion of the battery cover is foldable.

### BRIEF DESCRIPTION OF THE DRAWINGS

The aforementioned aspects and other features of the present invention will be explained in the following description, taken in conjunction with the accompanying drawings, wherein:

FIG. 1 is a graph showing a life of a battery under different temperature conditions;

FIG. 2 is a perspective view illustrating a battery cover according to the present invention; and

FIG. 3 is a cross sectional view illustrating a layer structure of a battery cover according to the present invention.

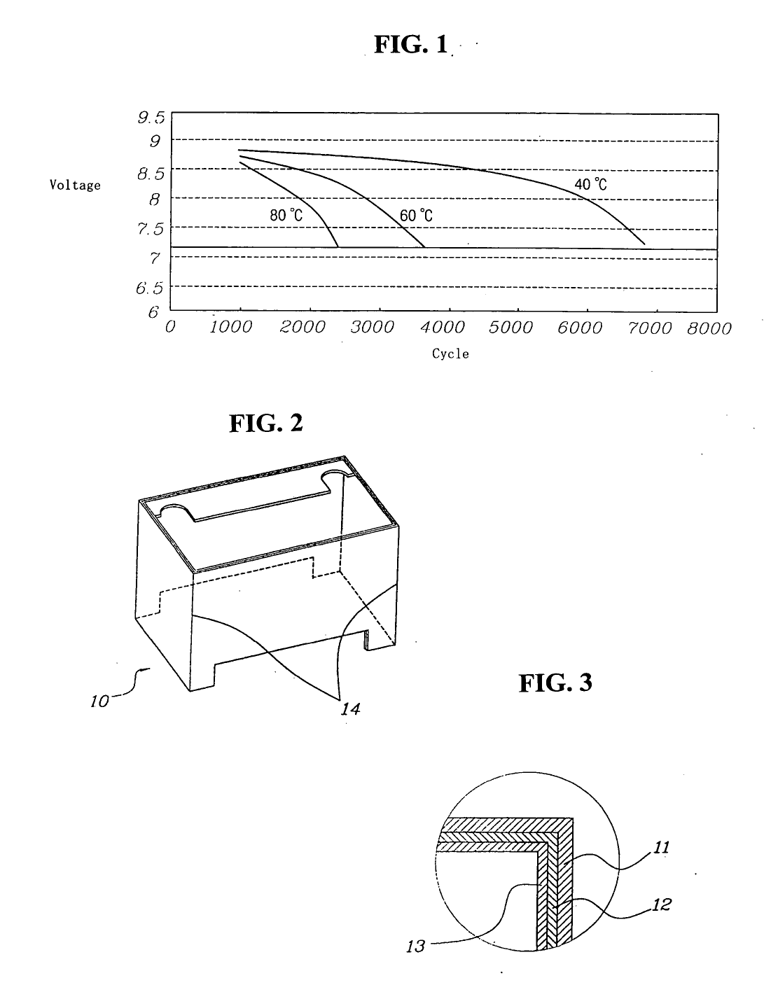

### DETAILED DESCRIPTION OF PREFERRED EMBODIMENTS

Hereinafter, such embodiments of the present invention are described in detail with reference to the accompanying drawings.

As shown in FIGS. 2 and 3, a battery cover 10 according to an embodiment of the present invention covers an outer surface of a battery for protecting the vehicle battery from surrounding heat and is formed of three layers. The outermost layer of the battery cover 10 is formed of a convection heat isolation member 11. Here, the convection heat isolation member 11 is preferably a submerging type non-woven fabric fabricated in such a manner that a fiber is provided in a synthetic adhesive container and dried and heat-treated. In general any synthetic adhesive may be used subject to known environmental parameters. Persons of ordinary skill may select an appropriate material.

In addition, a layer inside of the convection heat isolation member 11 is formed of a conduction heat isolation member 12. In a preferred embodiment of the present invention, the conduction heat isolation member 12 is made of glass fiber having a porous air layer.

A layer inside of the conduction heat isolation member 12, namely, the innermost layer of the battery cover 10 according to the present invention is made of a radiant heat isolation member 13.

In a preferred embodiment of the present invention, the radiant heat isolation member 13 is preferably made of an aluminum panel for thereby effectively isolating heat radiated from the battery.

Thus, a battery cover 10 according to an embodiment of the present invention is designed to isolate three known methods of heat transfer such as convection heat, conduction heat and radiant heat. Therefore, it is possible to obtain an effect that a liquid temperature of a battery is decreased by 17° C. as compared to the conventional art.

Since conventional battery covers are not foldable, they generally require a large space for storage (PP). Therefore, there are many limitations in terms of using a proper space. In the battery cover 10 according to the present invention, a corner portion 14 is folded. Therefore, when the battery cover is loaded in a working site, it is folded in a straight-line shape and is stored for thereby achieving a convenient transfer and loading operation.

As described above, the vehicle battery cover according to the present invention is implemented based on a three-layer structure of a convection heat isolation member, a conduction heat isolation member and a radiant heat isolation member, so that a battery cover according to the present invention is capable of isolating a convection heat, a conduction heat and a radiant heat. In the present invention, the effect of preventing temperature increase of a battery liquid is excellent due to the above-mentioned three-layer structure.

In addition, a corner portion of a battery cover may be folded. When storing or transferring a large amount of battery covers, the battery covers are folded and then transferred. In this state, when a user wants to use the battery cover, the folded portions are unfolded to be used, so that a large space is not needed, and it is possible to enhance convenience of its use.

1. A vehicle battery cover for protecting a vehicle battery from surrounding heat, comprising an outermost layer made of a convection heat isolation member, a middle layer disposed within the outermost layer and made of a conduction heat isolation member, and an innermost layer disposed within the middle layer and made of a radiant heat isolation member.

2. A vehicle battery cover according to claim 1, wherein said convection heat isolation member is made of a submerging type non-woven fabric fabricated in such a manner that a fiber is dipped in a synthetic adhesive container, dried and heat-treated.

3. A vehicle battery cover according to claim 1, wherein said conduction heat isolation member is made of glass fiber having a porous air layer.

4. A vehicle battery cover according to claim 1, wherein said radiant heat isolation member is made of an aluminum panel.

5. A vehicle battery cover according to claim 1, wherein a corner portion of the battery cover is foldable.

6. A vehicle battery cover, comprising:
an inner layer configured to surround a battery, said inner layer comprising an aluminum panel for radiant heat isolation;
a middle layer disposed around at least a part of the inner layer, said middle layer comprising a porous glass fiber material; and
an outer layer disposed over said middle layer, said outer layer comprising a non-woven fabric.

7. The vehicle battery cover of claim 6, wherein the non-woven fabric is saturated with a synthetic adhesive.
